(19) United States
(12) Patent Application Publication
(10) Pub. No.: US 2009/0312000 A1
(43) Pub. Date: Dec. 17, 2009

(54) ENVIRONMENT RESPONSIVE MOBILE COMMUNICATION DEVICE OPERATION

(75) Inventors: Ivan Nelson Wakefield, Cary, NC (US); Peter Joseph Ina, Cary, NC (US); Patrik N.G. Heuman, Cary, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communicatins AB, Lund (SE)

(21) Appl. No.: 12/174,178

(22) Filed: Jul. 16, 2008

Related U.S. Application Data
(60) Provisional application No. 61/061,372, filed on Jun. 13, 2008.

(51) Int. Cl. H04M 1/00; H04Q 7/20

(52) U.S. Cl. 455/418; 455/567

(57) ABSTRACT

A parameter of a mobile telephone operation, such as type of ringtone and/or ringtone volume, is changed upon determination that the mobile telephone is within an enclosed container or environment such as a briefcase, a purse, a pocket, or the like. Near field communication technology is utilized to detect proximity of the telephone within the enclosure. The parameter of the mobile telephone also may be changed upon determination that the telephone is in a noisy environment such as crowded room or stadium.

### TECHNICAL FIELD

The present disclosure relates to mobile communication devices, more particularly, modification of operation of a mobile telephone in accordance with its sensed environment.

### BACKGROUND

Mobile communication devices, such as cellular phones and the like, have become increasingly prevalent. These devices provide the convenience of a handheld communication device that is capable of increased functionality. An expanding variety of additional features have become available, for example, short or multimedia messaging, multimedia playback, electronic mail, audio-video capturing, interactive gaming, data manipulation, web browsing, and the like. Other enhancements, such as, location-awareness features, e.g., global position system (GPS) tracking, enable mobile communication devices to monitor their position and present their location via a local display.

Mobile telephone usage has expanded to include so many aspects of everyday life that it has become more than a luxury. For example, business people need to be in constant touch with their offices, parents need to be available for calls from their children. Many mobile telephone users feel the need to always be available to receive calls. Often, however, a mobile telephone may be situated in an environment in which it is difficult for the user to hear the telephone ringtone that indicates an incoming call. For example, the phone may be in a confined space such as in a user's pocket, purse, or briefcase. The ringtone sound may also be missed by the user when in a noisy environment such as an entryway, crowded room or stadium. Therefore, the need exists for an improved ability to alert users to incoming calls when mobile telephones are in such environments.

### DISCLOSURE

The above described needs are fulfilled, at least in part, by detecting when a mobile telephone is within an enclosed environment, such as a briefcase, a purse, or a pocket, or in a noisy environment. In response to such detection, an operating parameter of the mobile telephone is modified to alert the user an incoming call. The ringtone may be modified to increase its default decibel level output so that a user will be able to discern the ringtone even if muffled by the enclosed environment. Additionally, the ringtone may be changed to a more distinctive characteristic that is more easily distinguishable by the user from loud ambient noise.

Near Field Communication (NFC) technology may be used for detecting the presence of the telephone within a confined area, such as a briefcase, a purse, or a pocket of an article of clothing. Such a detection system employs an NFC reader in the telephone. An NFC tag may be attached to, or embedded in, the inside of the enclosure. The strength of the near field communication signal is of a level such that the NFC reader will indicate proximity of the telephone within the enclosure. The tag may be a passive element that interacts with a signal generated by the reader in the telephone, or may have the capability of generating near field signals. In either case, the telephone may be considered to be responsive to a proximity signal generated within the enclosure to recognize that it is located therein.

To address the possibility that the enclosure may be insufficient to prevent detection of the near field signal in its immediate exterior, an additional proximity detector may employed in the telephone. For example, a light sensor, such as an omnidirectional infrared sensor, will indicate light level in the telephone environment. If no light, or a small amount of light below a threshold amount, is detected in any direction, the telephone controller will respond to an enclosed environment condition. If a substantial amount of light is detected, the telephone can disregard a near field communication signal on the basis that the phone is near to, but not within, the enclosed environment.

The telephone may also be configured to respond to the detection of an enclosed condition by inhibiting a default function of the telephone. For example, a telephone of a clam-shell, slider-type telephone, or rotator-type configuration may normally be responsive to an incoming call to open its cover automatically. In response to an enclosed environment condition, however, this feature can be overridden to avoid damage to the telephone structure.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is an illustration of a mobile telephone located externally to an enclosed environment in accordance with an exemplified embodiment of the disclosure.

FIG. 2 is an illustration of a mobile telephone located within an enclosed environment in accordance with the exemplified embodiment of the disclosure.

FIG. 3 is a block diagram of telephone components used for implementing the embodiment illustrated in FIGS. 1 and 2.

FIG. 4 is a flowchart of one example of operation of the disclosure.

FIG. 5 is a flowchart of another example of operation of the disclosure.

### DETAILED DESCRIPTION

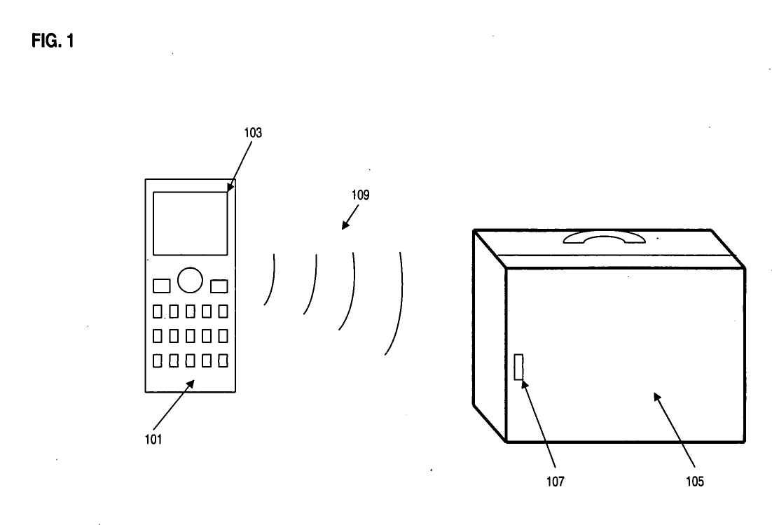

As shown in FIG. 1, mobile telephone 101 is at a location external to a confined enclosure, exemplified by a briefcase 105. Within or on the telephone housing is a near field communication (NFC) reader 103. The briefcase, 105, bears an NFC card, or tag, 107 within its interior. NFC is a short-range wireless system, well-known in the art, which is enabled by moving two NFC-enabled devices within a short, unobstructed, distance of each other. Signal communication can take place between two NFC devices within the operable range.

NFC technology, as well-known to those skilled in the art, combines the functions of a contactless reader, a contactless card, and peer-to-peer communication. Operating at 13.56 MHz, NFC technology is defined in the ISO 18092 and ISO (International Organization for Standardization) 21481, ECMA (340, 352 and 356) (European association for standardizing information and communication systems) and ETSI TS 102 190 standards. NFC is compatible with Sony's FeliCa™ contactless card. Typically, NFC card devices are not active devices. An antenna is a source of power via the sensed signal. When a device bearing an NFC reader is within range of a second device bearing an NFC tag, the device bearing the reader can obtain information in the tag and implement programmed action.

As shown in FIG. 1, telephone 101 emits a near field signal 109 when powered on. This signal is obstructed by the peripheral walls of briefcase and thereby prevented from communicating with NFC tag 107, located within the enclosure. As the NFC reader 103 does not detect communication with NFC tag, normal telephone operation is not affected. The telephone will respond to an incoming call by generating its normal, or default, ringtone. As the telephone is not within an enclosed environment, the ringtone should be discernable by the telephone user.

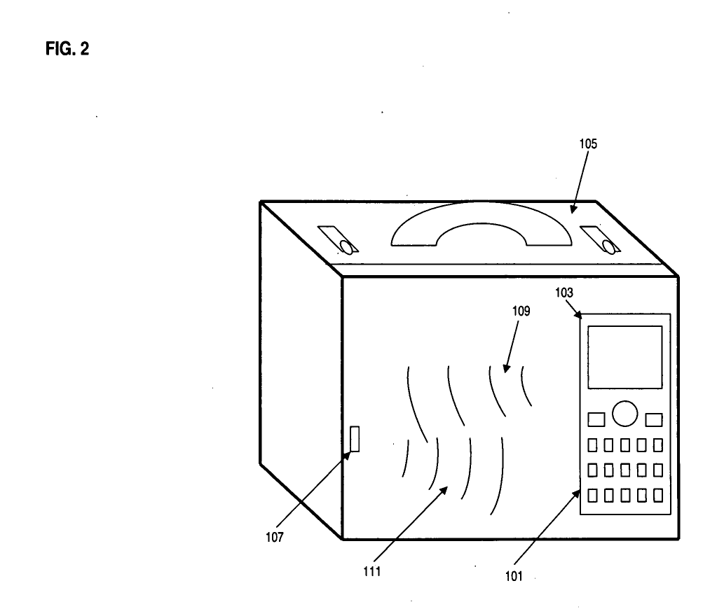

FIG. 2 is an illustration of the telephone 101 situated within the briefcase 105. Generation of a normal ringtone in response to an incoming call is less likely to alert the user of the call due to the noise muffling effect of the enclosure. However, the internal space of the enclosure is within the near field communication operating range of NFC reader 103 and NFC tag 107. A near field signal 109 is emitted from the telephone 101 and a return near field signal 111 is returned from the NFC tag 107. Signal 111 may be a modulated signal that contains information relevant to the NFC tag 107, or merely may indicate that the telephone 101 is in proximity to the NFC tag, and thus within the enclosure. NFC reader 103 provides such information to the telephone processor, which can then change the ringtone setting to an increased volume and/or a different ringtone, as more fully described below. The telephone user thus will be more definitively alerted to an incoming call.

A NFC tag may be installed in any enclosed area that the user may contemplate for storing the mobile phone, for example a purse or pocket of a garment. The size of NFC tags may make them amenable to inclusion generally in articles of manufacture. For example, placement of radio frequency identification (RFID) tags by large clothing retailers has become commonplace. Such tags may be utilized for near field communication with NFC reader 103 on the mobile telephone. It should also be understood that the confined enclosure itself may be configured with an NFC reader for communication with an NFC tag or reader of a device placed within the enclosure.

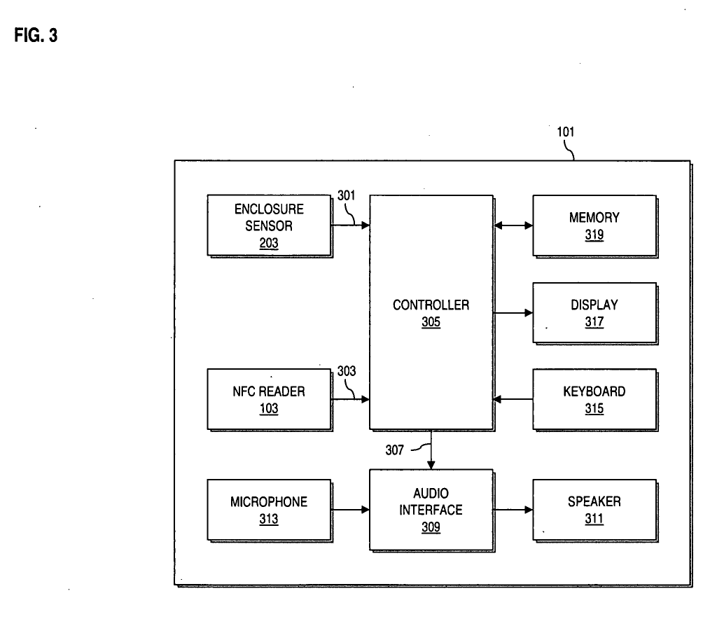

FIG. 3 is a block diagram of telephone components used for implementing the embodiment illustrated in FIGS. 1 and 2. Processor 305 is coupled to keyboard 315, display 317 and memory 319 in any well-known mobile telephone configuration. Similarly, as is well-known, the processor may provide output to speaker 311 and receive input from microphone 313 via audio interface 309. Processor 305 is additionally coupled to NFC reader 103 and enclosure sensor 203 via links 303 and 301, respectively. Enclosure sensor 203 may be an optical provision to avoid a false indication when an enclosure cannot completely obstruct the transmission of near field communication signals. For example, the phone may place directly on the exterior of the enclosure with the NFC reader enabled to pick up a weak NFC signal generated from within the enclosure. Enclosure sensor 203 acts to corroborate that the proximity of the telephone with the NFC tag is entirely within the enclosure.

Each NFC tag or reader has stored in a memory therein, data relative to the identification and specifications of an NFC device. Thus, in the present invention, the identification and specifications, or functionality, of the mobile telephone may be stored in the mobile telephone itself or it may be stored in the NFC tag within the enclosed container and this information may be obtained responsive to a control signal from the NFC tag in the enclosed container, e.g., a briefcase. The relevant stored information may include, among other things, characteristics of the mobile telephone such as the type of ringtone used to indicate an incoming call and the ringtone volume setting, information as to the type of mobile telephone, e.g., flip phone, slider phone, rotator phone, etc., whether it is an automatic opening phone on detection of an incoming call, etc., and all relevant information regarding the functionalities of the mobile telephone and protocols necessary for communicating with the mobile telephone and accessing those functionalities.

The signal 301, indicative of whether the mobile telephone 101 is within the enclosure, e.g., briefcase 105, is output from the enclosure detector, such as detector 203. The signal 303, indicative of the proximity of the NFC devices 103, 107 and of the functionalities and characteristics, for example, of the mobile telephone 101, is output from the NFC reader 103. The functionalities and/or characteristics of the mobile telephone 101 are stored, for example, in a memory either within the mobile telephone 101 itself, or in the NFC tag. The output signals 301 and 303 are then input to a processor 305 within mobile telephone 101. The processor 305 takes all the information from the enclosure/proximity detector and from the NFC reader, including the functionalities and characteristics of the mobile telephone 101 and processes the information, either by software or through hardware such as a logic circuit and outputs an activation signal on line 307, changing a parameter/characteristic of the mobile telephone 101, at 309, e.g., changes the ringtone to a ringtone different from the normally set ringtone, or increases the volume of the normally set ringtone, or both, if the processor determines that there is an incoming call and the mobile telephone 101 is within the NFC range of the NFC tag within the enclosed container, e.g., a briefcase, and the mobile telephone 101 is, in fact, within that enclosed container.

Enclosure detector 203 may be any of various known devices including, for example, an ambient sound detector or a light detector, attached to, or located within, the mobile telephone. An ambient sound detector can detect an ambient decibel level that is below a first predetermined threshold level to indicate relative isolate from the outside environment. As an additional feature, the ambient sound detector can detect an ambient decibel level that exceeds a second predetermined high threshold level that is indicative of an extremely noisy level of the outside environment. With such a noisy environment, a normal ringtone may be missed by the user. When the second threshold level is reached, the input from the sound detector can be used trigger the processor to increase the ringtone volume even though the telephone is not situated within an enclosure.

Alternatively, the enclosure may comprise a light detector, preferably omnidirectional, to provide a signal indicative of an ambient light level of the telephone environment. The light detector may be responsive to visible or infrared light. An output of the light detector above a predetermined threshold is indicative that the telephone is not within a closed environment.

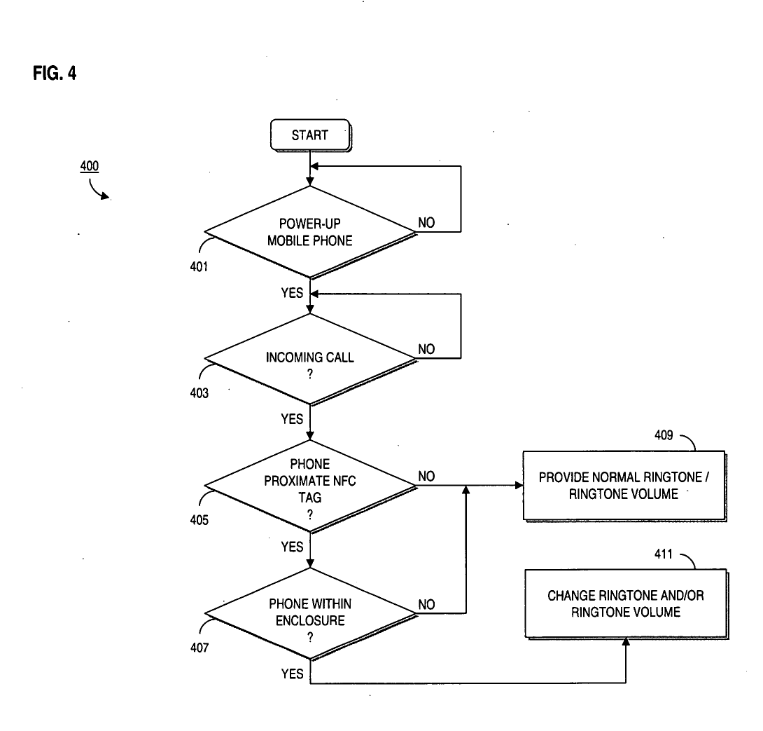

FIG. 4 is a flowchart of one preferred embodiment of the process of the present disclosure using, as exemplary, and not limiting, a mobile telephone as the mobile device, and a briefcase as the enclosed container. The first step in the process 400 is to determine, at decision block 401, if the mobile telephone is powered up. If it is not, the process merely loops back to checking if the mobile telephone is powered up. If the mobile telephone is powered up, the process moves on to decision block 403 to determine if there is an incoming call. If there is not, the process loops back to determining if there is an incoming call.

If an incoming call is sensed, then the process moves on to decision block 405 to determine if the mobile telephone is within range of the NFC tag within the briefcase. If it is not, then a default normal ringtone and/or normal ringtone volume is provided to alert the user of the incoming call at step 409. However, if it is determined that the mobile telephone is within range of the NFC tag within the briefcase, then the process continues to decision block 407 to determine if the mobile telephone is within the briefcase (or some other enclosed environment).

Step 407 is applicable for enclosures that may not provide complete isolation to near fields. In such an environment, NFC communication might be established if the telephone is exterior, but close, to the enclosure. To avoid such false indications, the phone may be provided with a light or audible sensor (enclosure sensor 203) to corroborate or refute the presence of the phone within the enclosure, decision block 407. With enclosures that provide relatively complete NFC isolation, step 407 may be omitted.

If it is decided at step 407 that the mobile telephone is not within the enclosure, then the process reverts to step 409 and the default ringtone volume is provided to alert the user of the incoming call. However, if it is determined at step 407 that the mobile telephone is within the enclosure, then either the ringtone is changed to another, perhaps more prominent, ringtone and/or the ringtone volume is increased from the default volume in order to make it more likely that a user will hear the ringtone indicative of the incoming call.

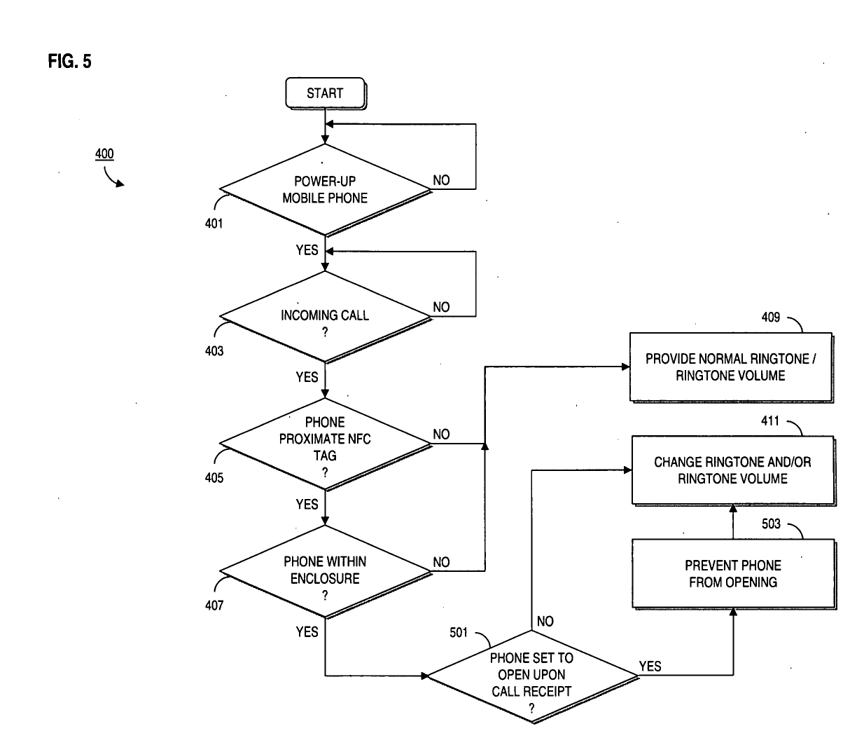

In another preferred embodiment, a telephone may be configured to prevent its automatic opening responsive to an incoming call in the event that the phone is within confined enclosure. Normally, a self-opening type of mobile telephone will open, e.g., flip open in a flip phone, upon receipt of a call. However, there may be insufficient space for these types of phones to fully open when the mobile telephone is within a confined container, such as a briefcase, a purse, or a pocket. NFC communication will provide self-opening prevention in this embodiment, in addition to changing a parameter, such as type of ringtone or ringtone volume, of the mobile telephone if the mobile telephone is confined. Operation is illustrated in the flow chart of FIG. 5.

The flowchart 500 of FIG. 5 illustrates another preferred embodiment of the invention. FIG. 5 is similar to that of FIG. 4, with the addition of another decision block, 501, between decision block 407 and block 411 for activating the change in ringtone and/or ringtone volume. In that case, where it has been determined that the mobile telephone is both within range of the NFC tag and is within the briefcase, the determination is made as to whether the mobile telephone is of the type that normally opens upon receiving a call. If not, the process continues to block 411 wherein the appropriate parameter change or changes is/are made. If the mobile telephone is of the type that opens upon receiving a call, then the process prevents the mobile telephone from opening, at block 503, and then continues on to block 411 for causing the appropriate parameter change or changes.

While the invention has heretofore been described with regard to a mobile telephone within an enclosed container, the invention is also useful in other situations such as noisy environments. For example, rather than placing the NFC tag within an enclosed environment such as a briefcase, purse, pocket, or the like, an NFC tag may be placed in the entryways to crowded venues such as, for examples, stadiums. The NFC tag may be placed on or embedded in a wall or other structure a user may be near when an incoming call occurs. This would enable a louder ringtone, for example, in the manner described above, when a user finds himself/herself in noisy environments. Of course, in these situations, if an ambient sound sensor is employed on the mobile telephone, rather than determining the mobile telephone to be inside an enclosed container and increasing the volume of the ringtone upon a sensing of ambient noise below a certain predetermined threshold, as described above, in the noisy environment, a determination that the ambient sound is above a certain predetermined threshold would trigger the parameter change such as an increase in ringtone volume.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein.

What is claimed is:

1. A method of operating a mobile communication device, comprising:
sensing that the mobile communication device is situated in a confined area; and
responsive to the sensing step, modifying a parameter of the mobile communication device.

2. A method as recited in claim 1, wherein the mobile communication device comprises a mobile telephone and the step of modifying comprises changing a ringtone of the mobile telephone.

3. A method as recited in claim 1, wherein the step of modifying comprises increasing the ringtone volume.

4. A method as recited in claim 1, wherein the step of modifying comprises inhibiting an operational feature of the mobile communication device.

5. A method as recited in claim 4, wherein the mobile communication device comprises a mobile telephone and the operational feature comprises automatic opening of a cover of the telephone in response to an incoming call.

6. A method as recited in claim 1, wherein the sensing step comprises receiving a proximity signal originating from within the confined area.

7. A method as recited in claim 6, wherein the step of modifying comprises increasing the ringtone volume of the mobile communication device.

8. A method as recited in claim 6, wherein the step of modifying comprises changing a ringtone of the mobile communication device.

9. A method as recited in claim 1, wherein the mobile communication device comprises a mobile telephone, and the step of sensing that the mobile communication device is situated in a confined area comprises detecting that the noise level of the confined area is less than a predetermined decibel level.

10. A method as recited in claim 9, wherein the modifying step comprises changing the ringtone volume of the mobile telephone.

11. A method as recited in claim 9, wherein the modifying step comprises changing the ringtone of the mobile telephone.

12. A method as recited in claim 1, wherein the mobile communication device comprises a mobile telephone, and the step of sensing that the mobile communication device is situated in a confined area comprises detecting that the light level of the confined area is less than a predetermined light level.

13. A method as recited in claim 12, wherein the modifying step comprises changing the ringtone volume of the mobile communications device.

14. A method as recited in claim 12, wherein the modifying step comprises changing the ringtone of the mobile communications device.

15. A mobile communication device, comprising:
a processor;
a near field communication (NFC) reader coupled to the processor;
wherein the processor is configured to modify an operating parameter of the mobile communication device in response to receipt of a proximity signal received by the NFC reader;
and wherein the proximity signal originates from an NFC source within an enclosed environment.

16. A mobile communication device as recited in claim 15, wherein the modifying step comprises changing the ringtone.

17. A mobile communication device as recited in claim 15, wherein the modifying step comprises changing the volume of the ringtone.

18. A mobile communication device, comprising:
a processor; and
an ambient noise sensor coupled to the processor;
wherein the processor is configured to modify an operating parameter of the mobile communication device in response to receipt of a noise signal received by the noise sensor.

19. A mobile communication device as recited in claim 18, wherein the mobile communication device is a mobile telephone and the modifying step comprises changing the volume of the ringtone of the mobile telephone.

20. A mobile communication device as recited in claim 18, wherein the mobile communication device is a mobile telephone and the modifying step comprises changing the ringtone of the mobile telephone.
